(19) United States
(12) Patent Application Publication
(10) Pub. No.: US 2014/0012947 A1
(43) Pub. Date: Jan. 9, 2014

(54) Apparatus for controlling communication between a host system and control devices

(71) Applicant: Softing AG, Haar (DE)

(72) Inventor: Dieter SCHALLER, Stuttgart (DE)

(21) Appl. No.: 13/934,475

(22) Filed: Jul. 3, 2013

(30) Foreign Application Priority Data
Jul. 6, 2012 (DE) 10 2012 106 077.0

(51) Int. Cl. H04L 29/08

(52) U.S. Cl. CPC H04L 67/02
USPC 709/217

(57) ABSTRACT

Apparatus for controlling communication between a host system and devices in a network, the apparatus comprising: a diagnosis interface for communicating with the devices; a WLAN interface for communicating with the host system; a WLAN module for controlling data communication between the apparatus and the host system via the WLAN interfaces; a diagnosis module for preparing data for communication with the host system; a communication module for controlling communication between the diagnosis module and the devices; wherein the WLAN module and the diagnosis module are implemented in a common WLAN processor; wherein the communication module is implemented in a separate communication processor, the processor including a real-time capable operating system.

### FIELD

Examples of the invention relate to an apparatus for controlling communication between a host system and control devices in an on-board network of a motor vehicle. Such apparatus are known in the prior art as vehicle communication interface, VCI.

### BACKGROUND

In current motor vehicles, a large number of control devices and control computers as well as sensor devices are being used. They are connected within the vehicle via an on-board network, which may be realized as a bus system, and can exchange data among each other. They also can be addressed by an external higher-ranking host system via an interface. The control devices, control computers and sensor devices, in the following referred to as control devices, carry out a large number of different control and monitoring functions and are part of complex systems, such as motor and gear control, anti-blocking systems and the like. Because the control devices must be able to control time-critical processes, such as brake retardation, they must be able to operate within a fine time pattern and/or in real time. Accordingly, also the communication among the control devices must be realized within this fine time pattern, in real time. Also for external communication from/to the control devices of the vehicle it is necessary to have a system which can operate in real time, such systems commonly being referred to as vehicle communication interface, VCI. A VCI is an intermediate or interface between a host system which cannot operate in real time, such as a service or diagnosis computer, usually a customary PC, and the real-time communication of the vehicle. For communicating with the control devices of the vehicle, there are a number of vehicle-specific protocols, such as the standardized protocols for K-Line, L-Line or CAN (controller area network) bus. Additionally, the VCI can assume hardware tasks, such as adapting the host system to the voltage level of the vehicle, such as 12 V or 24 V, and galvanic separation of the on-board system of the vehicle from the host system. The diagnosis buses K-Line and CAN, for example, have different physical properties when compared to a PC; accordingly, the VCI can also assume physical layer communication (e.g. according to the ISO/OSI model). In this case, the VCI is a gateway according to the ISO/OSI model which, depending on the protocol, realizes one or more of layers 1 to 7. Besides communication, the VCI can take on further tasks, such as providing digital inputs, e.g. for detecting ignition; digital outputs, e.g. for switching vehicle functions; analog inputs, e.g. for measuring battery voltage; and analog outputs, e.g. for supporting particular protocols.

A VCI generally has at least three tasks, namely communication with control devices in an on-board network of a vehicle in real time, preparation of data for communication with the host system, taking into account different communication protocols, and sending and receiving data to and from the host system. For communicating with the host system, there are different devices available which support USB interfaces, Ethernet interfaces, WLAN interfaces or also communication via Bluetooth or GSM/UMTS. The main task of the VCI hence is the provision of a communication interface between the vehicle and the host system, in particular for the purpose of diagnosis, and this is why a VCI is also referred to as a diagnosis interface. In addition, it can assume further tasks, such as recording of operation data of the vehicle, the distance covered and the current position (data logging) during a test run, uploading new firmware into the on-board network of the vehicle (flashing) as well as providing a protocol of bus accesses and connection quality (analyzer).

Customary diagnosis interfaces which fulfill one or more of the above tasks are, for example, the wireless diagnostic interface WDI and the diagnosis interface MDI-G of Daten- and Systemtechnik GmbH, Aachen, Germany; the diagnosis radio device VAS 5054A of Softing AG, Haar, Germany; and the wireless OBD interface “Intelligence Star Interface Logger” of Berger Electronic, Sindelfingen, Germany. Devices are further described in DE 10 2004 005 680 A1 of Bayerische Motorenwerke AG, and CN 102120441A of Actia Automotive Electronics. Further diagnosis interfaces are described in EP 0 374 998 B1, EP 1 992 932 A2 and EP 2 037 420 A2.

In summary, it hence is an important task of a VCI to control communication between a host system, such as a PC and the on-board network of a vehicle. Communication with the PC can be made via WLAN, a USB terminal or an Ethernet bus, for example, and communication to the on-board network of the vehicle can be made via an OBD (on-board diagnosis) interface according to the standards CAN or K-Line, for example. Additionally the VCI can assume tasks such as data logging and flashing, but also the task of a simulator or protocol analyzer. A basic function of the OBD interface is error diagnosis wherein data for vehicle diagnosis can be read-out on defined OBD pins. The remaining configuration of ODB pins is specific to the manufacturer and allows to communicate with control devices in the vehicle. The basis of communication, as a rule, is standard question/answer scenarios; if a control device does not respond as expected, an error is detected. If diagnosis is performed during manufacture of a vehicle in which the VCI is installed and monitors communication with the control devices, for example, it is possible to optimize the production workflow, because it is not necessary to completely assemble and then test the vehicle, but errors can be detected immediately after assembly of respective components by performing function tests using the control devices.

Communication between the host system and the on-board network of the vehicle can be as follows, in a common scenario: the host system initializes the connection to the VCI, e.g. via WLAN, according to the TCP/IP protocol. Subsequently, the host system informs the VCI about the control devices in the on-board network to be communicated with, and the VCI starts communication with the control devices according to the vehicle specific communication protocol, such as CAN or K-Line. The host system sends a request to the VCI and the VCI translates this request into a request according to the vehicle specific communication protocol and sends the request to the control device. The response of the control device will be sent back from the VCI to the host system, after the protocols have been retranslated accordingly. In practice, the control device expects the requests within a time pattern which is manufacturer specific. For example, for a (hypothetical) control device, the time distance between two CAN frames must be 100 ms, but may not be larger than 1 s. The CAN frames hence should be sent at a rate which is 100 ms, or as close to 100 ms as possible, to achieve the highest possible transmission rate.

For realizing the above tasks, the diagnosis interfaces (VCIs) available on the market use a specialized microprocessor including a real-time capable operating system which controls communication between the higher-ranking host system and the on-board network of the vehicle. In many cases, a microcontroller is used, i.e. a microprocessor including RAM, ROM and communication interfaces. This helps to keep low hardware recources, power consumption and costs. An embedded software or firmware is running on the operating system for transporting and translating requests and responses between the host system and the control devices of the vehicle according to the specified communication protocols, the software or firmware knowing the respective peculiarities of the vehicle specific protocols. During this protocol translation, the device data, e.g. operating parameters, sent from the control devices remain unchanged.

In the prior art, there are different solutions for allowing the diagnosis interface to communicate via WLAN. One approach is to provide a WLAN access via a PCI or PCI express interface wherein this requires a relatively large space for connecting lines and driver devices and entails high power consumption. A further approach for providing a WLAN access is to use a USB interface. This, however, entails high latency times and cannot be realized for all WLAN standards, it for example is not possible for the standard 802.11n which supports multiple channels. Other solutions hence use an additional WLAN module, which, however, cannot be housed in smaller diagnosis devices and hence needs to be provided externally to the VCI proper. Ready-made WLAN modules are either too large or are having the wrong shape so that they cannot be fitted into diagnosis interfaces which must comply with a particular overall volume and/or shape. WLAN modules which comply with all WLAN demands also consume too much power and/or are too big.

Theoretically, it is also possible that the host system, e.g. a PC, communicates directly with the control devices in the on-board network of the vehicle. To make this happen, however, the PC software would have to be able to support all variants of vehicle specific protocols. Even in a simple vehicle, it is well possible that different protocols are used, e.g. the protocol KWP 2000 via K-Line and the protocol UDS via CAN bus. Accordingly, each PC would have to be programmed accordingly, which would be a large investment. One problem is caused by the fact that the main part of vehicle communication is not standardized and not known to the public; accordingly, the PC software of each computer would need to know the exact protocols and OBD pins. This, however, is not supported by the manufacturers. Moreover, on a PC, it is only with unreasonably high expense possible to fulfill timing requirements and other peculiarities of vehicle interfaces. This would be a too high burden for the computing power of normal PC applications. Depending on the protocol, for example, the timing must be controlled down to individual bits. Additionally, hardware is needed which provides for the physical terminals (transformation of CAN signals). This hardware would have to be coupled to the PC via either PCI or USB which would again require a microprocessor. Such a solution hence has not been pursued in practice so that, for communicating between a host system and an on-board network, it is common to use a VCI.

### SUMMARY

An apparatus for controlling communication between a host system and devices in a network is provided, in particular in an on-board network of a vehicle. The devices can be e.g. control devices, sensors and control units of a vehicle or an industrial facility. The apparatus comprises: a diagnosis interface, in particular an OBD interface, for communicating with control devices and a WLAN interface for communicating with a host system. For controlling data transmission between the apparatus and the host system via the WLAN interface, a WLAN module is provided; for controlling communication between the apparatus and the control devices, a communication module is provided. A diagnosis module is provided for preparing data within the apparatus, for communication with the host system. The WLAN module and the diagnosis module are implemented in a common WLAN processor; and the communication module is implemented in a separate communication processor, including an operating system which can operate in real time. The communication module, in one example, is a vehicle communication module and, in this example, the communication processor is a vehicle communication processor. When compared to known diagnosis interfaces, in the apparatus, the tasks are distributed differently between the various components of the apparatus. Different from the invention, in the prior art, the functions of the diagnosis module and the vehicle communication module have been realized in a common specialized microprocessor having a real-time capable operating system while providing a separate radio module for (optionally) providing a WLAN interface. In the prior art, the emphasis of hardware computing power was in the diagnosis module which, due to the integration with the vehicle communication module, must have been capable to run on a real-time capable operating system; in practice, this required relatively high-performing and expensive special-purpose processors for vehicle diagnosis. Because the apparatus provides a different distribution of tasks within the communication apparatus, it is possible to shift the computation-intensive functions of the diagnosis modules into the WLAN processor which may have an operating system not operating in real time and not even being able to operate in real time. The invention takes advantage from the fact that, due to the popularity of WLAN networks for mass market purposes, the performance of WLAN processors has been improved continuously. Because in WLAN networks, for improving data security, increasingly complex encryption technology is used, also the computing power of the customary WLAN processors needed to be improved so that the computing power of WLAN processors is superior to the computing power of available special-purpose processors for vehicle diagnosis interfaces. Due to the high commercial pressure of the mass market, increasingly more WLAN functionalities have been integrated into the known WLAN processors, these functionalities being offered in single-chip solutions. Electric power consumption and space requirements have been optimized, while there has not been a similar trend having regard to known control computers in the automotive market.

The invention hence shifts the tasks of processing data for communication with the host system, i.e. part of the tasks of the diagnosis module, and the tasks of communicating with the host system to one of these customary WLAN processors, while the remaining task of communicating with the control devices of the vehicle, i.e. the tasks of the vehicle communication module, are attributed to a simple vehicle communication processor. Only this vehicle communication processor needs to have a real-time capable operating system, but, because it has to deal with lesser tasks, it can be configured with lower space requirements and power consumption. The WLAN processor, which also assumes tasks of the diagnosis module, does not have to be able to operate in real time and hence also can be optimized having regard to space requirements and electric power consumption. The invention hence takes advantage of the fact that current customary WLAN processors have a high computing power and operate using standard operating systems, such as Linux, and further are comparable to other computing chips having regard to their processor capabilities; they hence also are suitable for data processing tasks other than WLAN communication.

Because customary WLAN processors, having regard to the inputs and outputs, are limited to network functionalities, such as WLAN and Ethernet, and because they usually cannot operate in real time, additional specialized hardware is used for communicating with the vehicle, namely the vehicle communication processor. Any chip having the necessary vehicle communication interfaces and an interface to the WLAN processor integrated therein, can be used as a vehicle communication processor. It should be able to operate in real time, e.g. have an interrupt structure, but it does not require any particular processor capabilities and no complex operating system. It hence can be relatively small and have low power consumption.

A possible interface between the WLAN processor and the vehicle communication processor is an Ethernet interface which is very powerful and has little terminals and hence requires little space.

An example of the apparatus, in addition to the WLAN interface, for communicating with the host system also includes at least one of a USB interface and an Ethernet interface, both of which also can be activated or controlled by the WLAN module.

Besides preparing data for communication with a host system, the diagnosis module also can be configured to detect and cache control data of the control devices wherein vehicle diagnosis eventually will be performed by the higher-ranking host system. This logging of operating data can be used for examining errors or simply for detecting operating data, such as consumption and speed, for example. On the other hand, the diagnosis module also can be used to update software or firmware in the control devices of the vehicle, such as by flashing.

Besides controlling communication to the host system, the WLAN module also can be configured to determine and store parameters having regard to the quality of the connection and communication. Further, it can be configured to provide a WLAN access point for connecting all devices in the vehicle having WLAN capabilities such as portable computers for data logging, PDAs (Personal Digital Assistant) or Smart Pads or Tablet Computers, such as the iPad etc, for display of the data and additional devices, such as GPS or UMTS gateways. The WLAN module also can support communication between vehicles (car to car communication), for example for collecting data in a main vehicle during a test run so that this data can be evaluated and compared already during the run.

A basic function of the apparatus, however, is diagnosis of control devices, performing tests on the control devices in the vehicle and updating software or firmware in the vehicle during the production or servicing of the vehicle. By providing different interfaces and different housing shapes, the apparatus can be used versatilely and can communicate with an external host system even when mounted in the vehicle at places which are hardly accessible, without having to provide obstructive cabling, for example. By providing a very powerful WLAN module and integrated WLAN antenna, the device can even broadcast from the vehicle when doors are closed.

As discussed above, in one example, the WLAN processor can have a multiple-purpose operating system, such as Linux. More particularly, it can operate with a higher clock rate and it can have a larger memory than the real-time capable operating system of the vehicle communication processor. While it may be expected that the power consumption of the vehicle communication processor usually will be smaller than the power consumption of the WLAN processor, the power consumption of both processors is still considerably lower than the power consumption of the special-purpose microprocessors which previously have been used in customary diagnosis interfaces.

In one example, the WLAN processor can be put in a power saving mode, and the vehicle communication processor can be configured to activate or wake up the WLAN processor when receiving a message from the vehicle. To this end, the vehicle communication processor can intercept vehicle communication. In another example, a motion sensor can be provided which is coupled to the vehicle communication processor and which, upon detection of motion, wakes up the vehicle communication processor to activate the WLAN module.

In one example, the WLAN processor and the vehicle communication processor are both mounted on a circuit board which provides a complete galvanic separation between the interface for communicating with the host system and the diagnosis interface for communicating with the control devices of the vehicle. If Ethernet is chosen as the interface between the WLAN processor and the vehicle communication processor, this has the additional advantage that the desired galvanic separation between the two processors is inherently implemented by this interface. The apparatus simply uses the galvanic separation provided anyway in the Ethernet interface.

In one example, the apparatus is housed in a small compact housing, the dimensions of which are not larger than about 120 mm×50 mm×25 mm and which hence stays within the standardized volume according to the standard ISO 15031-3 2004 G (including tolerances allowed by the standard). It is hence possible to provide, for the first time, a diagnosis interface for a vehicle which meets said limits for standardized design space, supports a number of different external interfaces, such as USB, Ethernet and WLAN, including the encryption based thereon, and has a power consumption which is sufficiently low so that the apparatus can be supplied via a USB terminal.

In one example, the housing does not include any mechanical switches and is made from one or several injection molded parts wherein a plug of the diagnosis interface, such as an OBD plug, is integrated with one of the injection molded parts. This allows to provide a diagnosis interface having a sealed housing and not needing active cooling, which is absolutely suitable for use in a garage environment.

For controlling the apparatus, capacitive switches may be provided.

In one example, the apparatus may include a connection system including contact elements and at least one magnetic device for implementing the Ethernet interface or any other wired interface, the magnetic device being configured to bring into contact and keep in contact the contact elements of an adapter to the contact elements of the Ethernet interface. Coupling systems of this type are described in DE 10 2010 028 791 A1, for example. In one particular example, a switch or push-button can be provided at the adapter, which is connected to a reset input of the Ethernet interface for resetting the apparatus. This allows a simple reset of the diagnosis apparatus via a button which is not provided on the diagnosis apparatus as such and hence cannot be actuated easily in error or without authorization.

Examples of the apparatus are described in the context of a diagnosis interface for a vehicle wherein a host system communicates with control devices in an on-board network of a vehicle via a WLAN module and a vehicle communication module. The invention is not limited to these examples and also can be used for communicating with other types of apparatus in different systems such as industrial facilities or the like.

### BRIEF DESCRIPTION OF DRAWINGS

Examples are now described with reference to the drawings.

FIG. 1 shows a schematic diagram of a diagnosis interface of the prior art;

FIG. 2 shows a schematic diagram of one example of the apparatus;

FIGS. 3a and 3b show perspective views of examples of the apparatus from above and from below, respectively;

FIGS. 4a and 4b show perspective views of another example of the apparatus from above and from below, respectively;

FIGS. 5a and 5b show a side view and a plane view of an example of an adapter for the apparatus.

### DESCRIPTION OF EMBODIMENTS

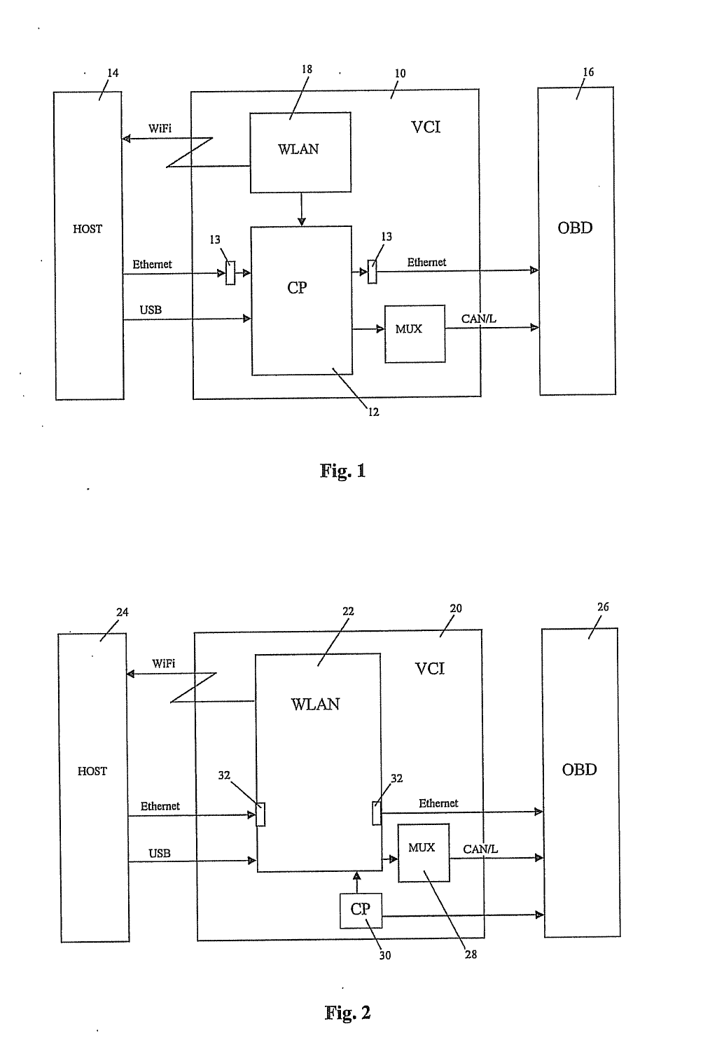

FIG. 1 schematically shows, in the form of a block diagram, the distribution of tasks in a diagnosis interface or vehicle communication interface, VCI, according to the prior art. Heart of the diagnosis interface 10 is a real-time capable communication processor 12 which controls communication between a higher-ranking host system 14 and the control devices of a vehicle 19, including necessary protocol translations, and which processes data from the control devices. The communication processor 12 supports e.g. Ethernet and USB interfaces to the host system and an OBD interface to the vehicle. The communication processor, as a rule, includes firmware which allows to make status reports to the host system and to detect, in real time, changes of states of the diagnosis interface proper or the control devices connected thereto and to communicate such state changes. The communication processor 12 further, as a rule, is configured to handle a number of parallel channels. It can be configured for operating systems, such as Microsoft Windows or Linux, for example.

In order to be able to provide wireless communication to the host system 14, diagnosis interfaces 10 of the prior art use a radio module 18 which, depending on the design, can be connected externally or integrated into a common housing of the diagnose interface. This may be a separate WLAN module 18 which transmits data from the communication processor 16 to the host system 14. The WLAN module 18 can be connected to the communication processor 12 via an Ethernet interface, a USB interface or a PCIe interface, for example. Further, according to demands, the communication processor 12 also can provide an Ethernet interface to the vehicle 16.

The solutions of the prior art have a basic structure which requires two powerful processors and hence requires a large design space and power consumption. The power consumption of the diagnosis interface is in the order of about 5 Watt. When trying to integrate the prior art solutions into smaller housings, substantial heat generation problems are created. Integrating the functions of the apparatus into a housing which complies with a standardized design space according to the standard ISO 15031-3 2004 G (about 120 mm×50 mm×25 mm) had not been possible up to now. Also, current requirements of the prior art solution are clearly above 500 mA so that power supply via a USB terminal is not possible.

A further disadvantage of the prior art solutions is that, for connecting host system 14 and communication processor 12 for connecting, communication processor 12 and vehicle interface 16, and for connecting communication processor 12 and radio module 18, additional external switches 13 are necessary which need to be adjusted separately. The switches 13 are for coupling the individual network segments, they are used as network switch points or distributor points, for relaying data packets between the components mentioned above. An external switch causes additional space and power requirements and possibly additional costs.

FIG. 2 schematically shows, in a block diagram, one example of the apparatus, which, for simplicity, also will be referred to as diagnosis interface 20, in the following. The diagnosis interface 20 provides basically at least the same functionalities as the diagnosis interface 10 of the prior art; however, it uses different types of processors and a different distribution of tasks so that, overall, the total space requirement and power consumption are reduced substantially and, at the same time, processor performance is increased. These objects are achieved by assigning the largest part of the tasks of the diagnosis interface 20 to a WLAN processor 22 which does not have to operate in real time but which has high computation power. The WLAN processor 22 provides a WLAN interface for communicating with the host system 24 and controls data communication between the host system 24 and the diagnosis interface 20 via this WLAN interface and also assumes the task of preparing data coming from the control devices of the vehicle 26 for communication with the host system 24. The WLAN processor 22 can be a customary WLAN chip which supports common interfaces such as Ethernet and USB, and which has high computation power. Compared to the usual communication processors 12 of the prior art, volume and power consumption of the WLAN processor 22 are divided by about two (half the size and power consumption), but processor performance is substantially increased. This is achieved, on the one side, because the WLAN processor 22 does not need to operate in real time and, on the other side, by taking advantage of the rapid development in the utilization of WLAN technology.

Because common WLAN processors 22 cannot operate in real time and do not support the vehicle specific communication protocols, the diagnosis interface 22 uses, in addition, a small vehicle communication processor 30 which, when compared to the communication processor 12 of the prior art and to the WLAN processor 22, has a smaller computation power, but can operate in real time. This vehicle communication processor 30 has the only task of controlling communication between the WLAN processor 22 and the control devices of the vehicle 26 and to perform the necessary protocol translation. It hence, essentially, only needs to perform protocol translation. The vehicle communication processor 30 can communicate with the WLAN processor 22 via an Ethernet interface, for example.

The diagnosis interface of this invention, when compared to the known VCIs, can be implemented using considerably less design space and less power consumption. It is possible, to limit the design space to a size of about 120 mm×50 mm×25 mm so that the interface can be housed in a housing which meets the specification of a standardized design space which, originally, had been defined only for the access cables. The apparatus, in its dimensions, hence meets the requirements of the respective ISO standard. The current consumption is at most 500 mA, usually less, and the power consumption is about 2.5 Watt. In one example it is possible to support all common vehicle specific protocols, such as CAN, K-Line and L-Line, via the vehicle communication processor 30. The WLAN processor allows to support all common WiFi standards according to the standard 802.11a/b/g/n, besides providing Ethernet and USB interfaces. The USB terminal can be used for configuring the apparatus from a PC, for example.

Using the WLAN processor 22 has the additional advantage that such processors comprise integrated switches 32 so that the complexity of the system is reduced and space requirements are further decreased.

The WLAN processor 22 of this example is connected to the vehicle interface via a signal multiplexer 28, just as in the embodiment shown in FIG. 1. The host PC can directly communicate with the vehicle via the signal multiplexer (e.g. via Ethernet DoIP).

Each of the two processors 22, 30 is used for those tasks for which it is optimized. The WLAN processor 22 is responsible for tasks requiring a high computation power, such as WLAN connection, administration of file systems, providing a USB interface and handling of diagnosis vehicle protocols, such as UDS and KWP2000; the vehicle communication processor 30 is responsible for real time control of the communication to the control devices of the vehicle and for transport protocol translations. The WLAN processor 22, in one example, can be a processor which usually is used in a DSL router; while the vehicle communication processor, in one example, can be a processor which is usually used in vehicle diagnosis within the vehicle. While the WLAN processor may, in one example, have a general purpose operating system, such as Linux, which is optimized for large data throughput and high computation power, the vehicle communication processor will have a real-time capable operating system, such as QNX, and can operate with considerably less computation power, memory and flash memory. While the clock of the WLAN processor, for example, is in the order of ≧500 MHz, the vehicle communication processor can operate based on a clock in the order of 12-80 MHz. This ensures a minimum power consumption. In one example, the WLAN processor can have about ten times the power of the vehicle processor, ten times the memory and ten times the clock frequency. More generally spoken, the processors should be configured with an optimum CPU for their respective tasks. For example, WLAN needs high computing power for encryption; vehicle diagnosis needs low computing power. For the WLAN module one hence selects a CPU which meets the requirements and also for the vehicle communication processor, a CPU is selected which meets the requirements—but there is no need for over performance. If over performance is provided, there can be problems with space and power consumption and with heat dissipation.

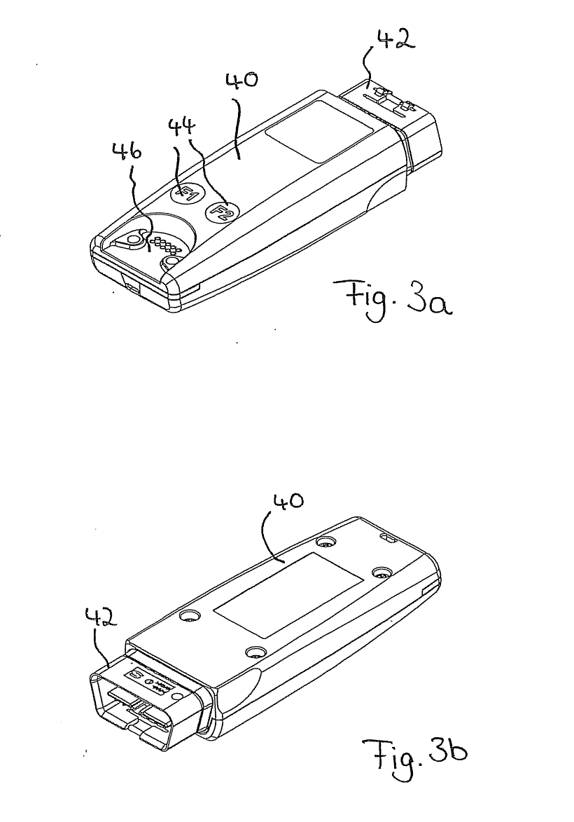

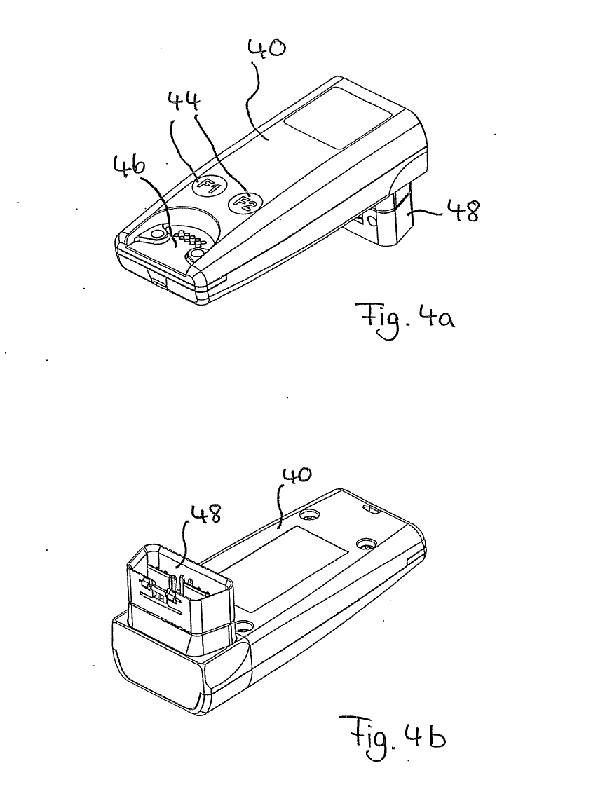

FIGS. 3a and 3b show perspective views of the housing, from above and from below, according to one example. An alternative example of the housing is shown in FIGS. 4a and 4b. Both housings have dimensions of not more than 120 mm×50 mm×25 mm.

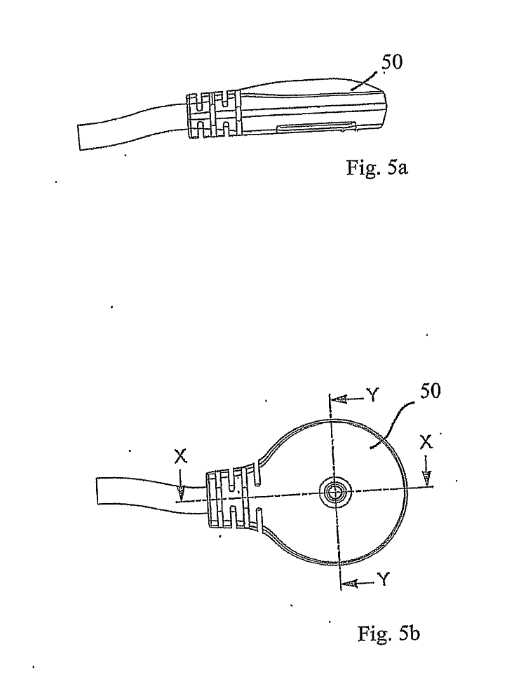

The housing shown in FIGS. 3a and 3b provides a main body 40 which can be assembled from e.g. two injection molded parts. An OBD plug 42 for connecting to an OBD interface of a vehicle, is provided in the same axis as the main body 40. The OBD plug 42 is integrated with one of the two halves of the housing 40. On the upper surface of the housing 40, there are two buttons 44 which can be provided above capacitive switches (not shown) for controlling, programming or resetting the diagnosis interface. Further, contact pins 46 extend from the housing to the outside for providing access to an Ethernet interface or other wired interface of the apparatus. These contact pins 46 can be brought into contact with an adapter 50, such as the one shown in FIGS. 5a and 5b, for example.

The housing shown in FIGS. 4a and 4b differs from the one shown in FIGS. 3a and 3b in that there is an angled OBD plug 48, which also can be integrated with one of the two housing halves during an injection molding process. Besides this difference, reference is made to description of FIGS. 3a and 3b.

FIGS. 5a and 5b show an adapter 50 which can be a so-called MagCode™ adapter which is brought into contact with the contact pins 46 and which is held in place by magnets. Instead of the buttons 44 shown in FIGS. 3a and 4a, or in addition to these buttons, another button or switch can be provided at the adapter 50 to control, program or reset the apparatus via one or more reset and programming inputs. These reset and programming inputs may be coupled with the diagnosis interface via one or more of the contact pins 46. In this example, it is possible to provide a diagnosis interface completely without switches or buttons and, in particular, without its own reset switch/button by exporting the desired controls to the adapter 50.

Instead of a MagCode adapter, as a matter of course, it is also possible to provide any other connecting mechanism between the adapter 50 and the contact pins 46.

What is claimed is:

1. Apparatus for controlling communication between a host system and devices in a network, the apparatus comprising:
a diagnosis interface for communicating with the devices;
a WLAN interface for communicating with the host system;
a WLAN module for controlling data communication between the apparatus and the host system via the WLAN interface;
a diagnosis module for preparing data for communication with the host system;
a communication module for controlling communication between the diagnosis module and the devices;
wherein the WLAN module and the diagnosis module are implemented in a common WLAN processor;
wherein the communication module is implemented in a separate communication processor, the processor including a real-time operating system.

2. Apparatus according to claim 1 wherein the WLAN processor includes a non-real-time operating system.

3. Apparatus according to claim 1, further comprising at least one of a USB interface and an Ethernet interface for communication with the host system wherein the WLAN module also controls data communication between the apparatus and the host system via the USB interface or the Ethernet interface.

4. Apparatus according to claim 1 wherein the diagnosis module transforms messages which are received from the host system via one of the interfaces, into control commands for the devices and transforms responses of the devices into messages, which are sent to the host system.

5. Apparatus according to claim 1 wherein the communication module functions as a vehicle communication module to transform control commands of the diagnosis module into control signals according to a defined vehicle communication protocol and to transform response signals of the devices into responses according to a communication protocol of the WLAN processor.

6. Apparatus according to claim 1 wherein the diagnosis module detects and stores operating data of the devices.

7. Apparatus according to claim 1 wherein the WLAN module detects and stores parameters having regard to the quality of connection.

8. Apparatus according to claim 1 wherein the WLAN processor comprises a general-purpose operating system, such as Linux, which has a higher clock rate and a larger memory than the real-time operating system of the communication processor.

9. Apparatus according to claim 1 wherein the power consumption of the communication processor is smaller than the power consumption of the WLAN processor.

10. Apparatus according to claim 1 which is configured to put the WLAN processor into a power saving mode; wherein the communication processor activates the WLAN processor upon receipt of a message.

11. (canceled)

12. Apparatus according to claim 10, further including a motion sensor which generates a signal when the apparatus is moved in order to activate the WLAN processor.

13. Apparatus according to claim 1 wherein the WLAN module is configured to provide a WLAN access point.

14. Apparatus according to claim 1 wherein the WLAN processor and the communication processor are mounted on a circuit board, the circuit board providing a full galvanic separation between the interfaces for communicating with the host system and the diagnosis interface for communicating with devices in the network.

15. Apparatus according to claim 1, including a housing, the dimensions of which are not larger than 120 mm×50 mm×25 mm.

16. Apparatus according to claim 15 wherein the housing does not have any mechanical switches.

17. (canceled)

18. Apparatus according to claim 1, further comprising capacitive switches for controlling the apparatus.

19. Apparatus according to claim 3 wherein the Ethernet interface comprises an electrical connection system to contact elements and at least one magnetic device, the magnetic device bringing into contact and maintaining in contact counterpart contact elements of an adapter with said contact elements.

20. Apparatus according to claim 19 wherein the Ethernet interface comprises a reset input which can be activated via the adapter when connected to the interface.

21. Apparatus according to claim 1 wherein the diagnosis interface is a field bus interface, including one of an on-board diagnosis interface and another field bus interface, such as CAN or Ethernet, and wherein communication between the host system and the diagnosis interface is provided via a field bus.

22. (canceled)

23. Apparatus according to claim 1 wherein the devices are control devices, sensor devices or control units of a vehicle or an industrial facility.

24. Apparatus according to claim 1 wherein the network is an on-board network of a motor vehicle.
